(19) United States
(12) Patent Application Publication
(10) Pub. No.: US 2010/0332212 A1
(43) Pub. Date: Dec. 30, 2010

(54) METHOD AND APPARATUS FOR SLEEP AND WAKE OF COMPUTER DEVICES

(76) Inventor: Ori FINKELMAN, Tel-Aviv (IL)

Correspondence Address: Pearl Cohen Zedek Latzer, LLP, 1500 Broadway, 12th Floor, New York, NY, 10036, US

(21) Appl. No.: 12/873,046

(22) Filed: Aug. 31, 2010

Related U.S. Application Data
(63) Continuation-in-part of application No. 12/560,765, filed on Sep. 16, 2009.
(60) Provisional application No. 61/098,242, filed on Sep. 19, 2008.

(51) Int. Cl. G06F 9/455; G06F 15/177

(52) U.S. Cl. 703/23; 709/221

(57) ABSTRACT

A system apparatus and method for emulating a computing device are provided. Operational parameters of a computing device may be obtained and provided to an emulating computing device. An emulating device may emulate an emulated computing device. While being emulated, a computing device may operate in a reduced functionality mode. Emulation of a computing device may be transparent to client or other machines associated with an emulated computing device. Conditions requiring a termination of an emulation of a computing device may be detected. Upon detecting conditions requiring a termination of an emulation of a computing device, operational or other parameters may be provided to the emulated computing device and the emulated computing device may assume full, or other, operational mode. Other embodiments are described and claimed.

### CROSS-REFERENCE TO RELATED APPLICATIONS

This application is a continuation-in-part application of U.S. patent application Ser. No. 12/560,765, filed on Sep. 16, 2009 entitled “System and method for emulating a computing device” which in turn claims benefit of U.S. Provisional Patent Application No. 61/098,242, filed Sep. 19, 2008, all of which are incorporated in their entirety herein by reference.

### BACKGROUND OF THE INVENTION

Various systems, methods, techniques or other means for saving resources, e.g., electric power, are known in the computing industry. For example, reduction of energy consumed by a computing device may be achieved by causing the computing device to enter a sleep, power save, stand-by or hibernation mode. Other methods or techniques may involve reducing the frequency or rate of a clock governing the operation of a central processing unit or other components. Yet other methods may shutdown components such as a display screen or a hard drive when suitable conditions are detected. Such methods and/or techniques typically involve detecting a time when a computing device is idle by monitoring or sensing absence of interaction with a human user, e.g., via an input/output device such as a keyboard and/or a mouse, for a predefined period of time.

However, such methods known in the art fail to provide a solution for many scenarios, systems and/or environments. For example, a server, e.g., a server remotely located in a datacenter, may not be equipped with human interface devices, such as mouse and/or keyboard. Accordingly, detecting idle time as described above may be impossible.

Another example may relate to mobile computing devices that, when put to sleep or otherwise assume reduced operational mode, may be incapable of receiving messages, notifications or indications from, and/or polling a, remote computing devices or applications. For example, a computing device such as a laptop may be used for communication, e.g., exchanging electronic mail or instant messages. However, methods known in the art fail to provide an adequate solution that saves energy or other resources while maintaining connectivity and/or other functionalities at an application level.

### SUMMARY OF EMBODIMENTS OF THE INVENTION

Embodiments of the invention may enable one or more computing devices to be emulated by another computing device, system or apparatus such that at least a network behavior of the emulated computing device and/or an application executed thereon is maintained by the emulating device, system or apparatus. In some embodiments, operational parameters of a computing device (e.g., a laptop computer) may be obtained and provided to an emulating computing device. An emulating device may emulate a computing device including maintaining a network presence of the computing device and/or applications executed thereon. While being emulated, an emulated computing device may operate in a power save mode or any other (possibly reduced) functionality or operational state or mode. Conditions requiring a termination of an emulation of a computing device may be detected by the emulated computing device or by the emulating device. Upon detecting conditions requiring a termination of an emulation of a computing device, operational or other parameters may be provided to the computing device by the emulating device and the computing device may assume or enter full, or other, operational mode in a manner transparent to networks and/or or devices interacting with the previously emulated computing device.

Embodiments of the invention may detect an emulation condition. An emulation condition may be a condition indicating a suitability of a first computing device to perform a set of emulated network operations of a second computing device normally performed by said second computing device when operating in a normal operational mode. At least a first network functionality parameter may be provided to the emulating computing device. The emulating computing device may be caused to perform at least some of the emulated network operations of said second computing device according to the network functionality parameter provided. The emulated computing device may be caused to assume or enter a reduced operational mode, wherein such reduced operational mode may be associated with reduced network operation with respect to a normal operational mode.

An awake condition may be detected and may indicate a need for a network operation of the emulated computing device. A network functionality parameter may be provided to the emulated computing device by the emulating computing device. The emulated computing device may be caused to assume or enter a normal operational mode and perform the network operation based on the provided network functionality parameter. The emulating computing device may be caused to cease emulating the emulated device.

According to embodiments of the invention, at least part of one or more selected applications associated with an emulated computing device may be associated with an emulating device, for example, application or part of an application executing on a computing device may be executed on an emulating device. Embodiments of the invention enable transferring an execution of an application from an emulated device to an emulating device. For simplicity and clarity, an application which had its execution transferred to an emulating device may be referred to herein as an “emulated application”. As described herein, transferring an execution of an application from an emulated device to an emulating device may be performed seamlessly, such that the application may maintain normal, undisturbed or unaffected operation, for example, network presence of an application may be maintained before, during and after a transfer of its execution from an emulated device to an emulating device and back. In some embodiments, operational parameters of an application may be provided to an emulating device such that various aspects related to an emulated application may be maintained by the emulating device. Conditions enabling an emulation of an application and/or requiring a termination of such emulation may be similar to those described herein with respect to emulating a computing device.

Embodiments of the invention may relate to an emulating device and an emulated device. Although for the sake of simplicity, detection of an emulating condition may be described as performed by the emulated device, it will be understood that an emulation condition may likewise be detected by the emulating device. Similarly, According to embodiments of the invention, an awake condition may be detected by either one of an emulated or emulating device. Similarly, an emulated device may be caused to cease or commence performing an application or part of an application by the emulating device or by itself, e.g., by an application executing on the emulated device. Likewise, an emulating device may be caused to cease or commence performing an application or part of an application by the emulated device or by itself, e.g., by an application executing on the emulating device. However, for the sake of simplicity and clarity, operations such as detecting an emulation or awake condition, causing a computing device to commence or cease an operation or communicating parameters will be described as performed by one of the emulated or emulating device.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows an exemplary high level architecture that may be used to implement some embodiments of the invention;

FIG. 2 depicts an exemplary time-event flow according to embodiments of the invention;

FIG. 3 is a flowchart diagram illustrating an exemplary flow according to some embodiments of the present invention;

FIG. 4 depicts exemplary components of an exemplary system according to some embodiments of the present invention;

FIG. 5 shows an exemplary computing device according to some embodiments of the present invention;

FIG. 6 shows an exemplary high level architecture that may be used according to some embodiments of the present invention; and

FIG. 7 is a flowchart diagram illustrating an exemplary flow according to some embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

Although embodiments of the invention are not limited in this regard, the terms “emulate” or “emulating” as used in this patent application specification should be expansively and broadly construed to include performing any functionality of an emulated device or application by an emulating device. In particular, emulating a device or an application may include performing network related functionality and/or emulating a network behavior, presence or it may comprise performing tasks related to a specific application. Any applicable operational or other aspects of an emulated device or application may be performed, carried out, executed, implemented, handled or assumed by the emulating device, e.g., handling and communicating over network connections, exchanging application specific messages, updating states, lists, tables or parameters associated with an application or performing any processing related to an application. According to embodiments of the invention, Emulating network, device or application related behavior, functionality or other aspects of a device may include emulating or performing functionalities related to some or all the seven layers of a network architecture as defined by the open system interconnection (OSI) model. For example, emulation of a device or application may include performing operations related to the physical, data, network, transmission and/or application layers.

As described above, there is a need to allow a computing device to enter and exit sleep mode, particularly in the absence of human interaction. Further aggravating the problem is the fact that the computing device may be required to be continuously available for various network communications. Methods currently in use for entering/exiting sleep mode are not suitable, as they may cause the loss of network presence of the computing device, e.g., render network connections unusable or failing to perform application specific operations, e.g., periodic exchange of application information, polling and the like, effectively disabling remote applications, users, servers and/or other computing devices from further effectively interacting with the computing device.

Embodiments of the invention may be applicable to various computing devices, including devices other than servers. For example, mobile devices such as mobile phones, notebook laptop, or tablet computers need to be put to sleep or otherwise assume low power or low functionality operational modes in order to extend battery life and/or extend the time they may be operated without being charged. However, when such computing devices are put on stand-by mode, sleep mode, or otherwise made to operate according to a reduced functionality mode, their central processing unit (CPU) is typically shutdown and accordingly, all applications or other executable codes are unable to execute. This poses a problem since usage of such mobile devices is frequently related to communication. For example, some of the most popular applications executed on such devices are electronic mail, messaging and voice over internet protocol (VoIP) applications. In order to emulate a device and/or an application over a network, various networks and applications protocols or other aspects must be observed and/or adhered to. For example, as described herein, maintaining network presence may be required in order to properly emulate a computing device and/or an application executed thereon. As described herein, a network presence of an application may be maintained by an emulating device while the application is idle on the emulated device.

For example and as known in the art, an application may be stateless or stateful. A stateless application may perform a task upon request and may then assume a default or known state. An execution of a task by such stateless application may typically be unrelated to previously performed tasks, past events, elapsed time, received messages, context and the like. In contrast, a stateful application or task may be in any one of many states that may be assumed as a result of elapsed time, received (e.g., over a network) commands or messages, interactions, logic or any applicable event, context or aspect. For example, an application may change its state based on messages exchanged with a remote application over a network. In some implementations and/or applications, exchange of periodic, asynchronous or other messages may be mandatory as dictated by a relevant protocol. According to embodiments of the invention, an emulating device emulating an application (e.g., by executing at least part of an application on behalf of the emulated device) may handle any relevant or related exchange of messages related to an emulated application such that execution of the application may be seamlessly transferred from an emulated device to an emulating device.

According to embodiments of the invention, an emulating device emulating an application may handle any state transition or other related issues or operations that may be required while the application is being emulated. For example, an application's state may be required to change based on a message received from a remote application. Accordingly, an emulating device, unit or module may change and record a state of an emulated application based on a received message. As described herein, parameters such as an application's state may be recorded by an emulating unit and may be transferred back to the emulated device upon terminating an emulation of an application. Accordingly, in some embodiments, an application may execute during a first period of time on a mobile computing device. Next, during a second time period, an emulating unit, device or system may receive a state parameter related to the application from the mobile computing device and execute the application or specific parts of the application, based on the received state parameter. During such second period of time, the application's state may change as a result of elapsed time, received or sent messages or other criteria or events. Upon terminating an emulation of the application as described herein, its state and any other relevant parameters may be communicated back to the mobile device where, during a third period of time, the application may be executed.

According to embodiments of the invention, synchronous, asynchronous or periodic operations related to an application may be performed by an emulating device on behalf of an emulated application. For example, emulating a mail client application may comprise polling a mail server, e.g., generating and sending messages according to the simple mail transfer protocol (SMTP). Accordingly, while emulating a mail client application, an emulating device may poll a mail server and check for arrival of new mail. An indication of presence of new mail on the mail server may cause an emulating device to terminate an emulation as described herein. Accordingly, embodiments of the invention enable a sleeping and emulated device to resume normal operation when a new mail message may be received. For example, an emulated laptop computer may be put to sleep or stand-by while being emulated and woken up when new mail arrives. For example, an emulating device may emulate a mail application by periodically polling a mail server on behalf of the emulated mail application and, upon determining that new mail is available at the mail server, emulation of the mail application may be terminated. Upon termination of an emulation of the mail application, the mail application (executing on the emulated device) may retrieve new mail from the server. Accordingly, a user may have his laptop or other computing or communication device put to sleep while still maintaining regular email reception. Such embodiments enable extending battery life of mobile devices without loosing connectivity provided by such devices.

When emulating an application, e.g., executing at least part of an application on an emulating device, security aspects may be observed or maintained and security related operations may be performed. For example, credentials as known in the art may be exchanged between applications as part of a security measure. According to embodiments of the invention, an emulating device may receive credentials from an emulated device and use such credentials, e.g., to authenticate itself to a remote server, obtain encryption and/or decryption keys and the like.

Some applications may be associated with a state that may reflect availability or presence of an associated user. For example, an application may be in one of “on line”, “off line”, “available” or “unavailable” states. In some applications, such states may be affected by the availability or presence of the application on a network. For example, in order to be designated as “available”, an application may need to respond to periodic messages from a remote server or it may be required to periodically inform a server of its availability. In some scenarios, various operations or functionalities are according to an availability or presence state. For example, if an instant messaging application is marked or indicated as unavailable, remote users may not communicate with the associated user. According to embodiments of the invention, an emulating device may maintain any aspect, context or parameter related to a presence or availability of an application on a network such that a desired state of the application is maintained. For example, an emulating device emulating a social network related application may periodically or otherwise exchange messages with a server, other user's devices or any other device such that the state of the user associated with the social network application is maintained as desired, e.g., a state of “online” may be maintained even though the user's computing device is in sleep mode. In such case, upon receiving an indication that a new message is available for the user, e.g., in a chat application, the emulation of the social network application may be terminated and the social network application (executing on the user's computing device) may handle the incoming message.

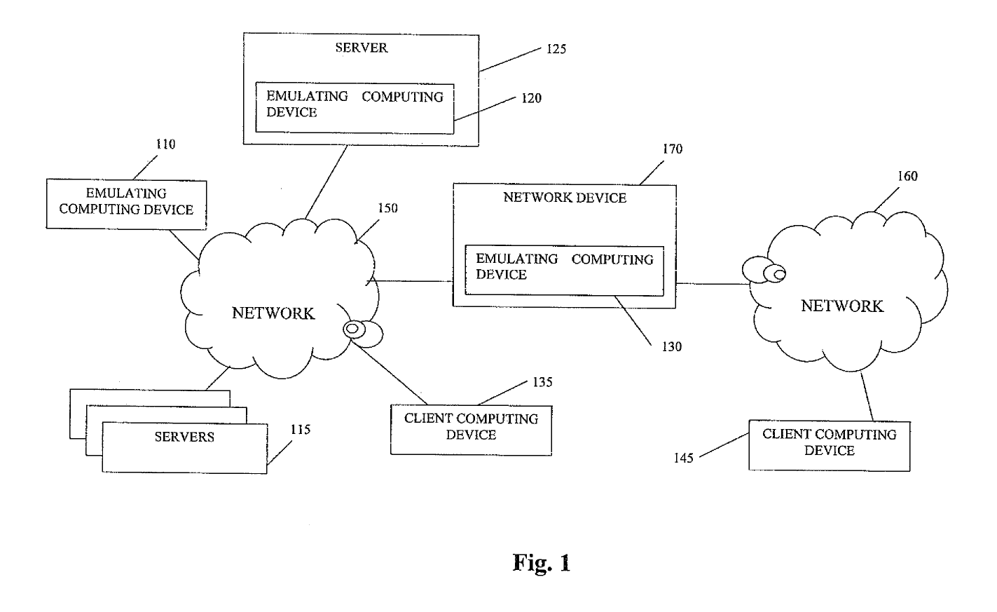

Reference is made to FIG. 1 showing an exemplary high level architecture that may be used according to embodiments of the invention. Servers 115 and 125 may be any computing device providing one or more services to users, applications and/or other computing devices, e.g., over a network. For example, servers 115 and 125 may be or may include, for example, a personal computer, a desktop computer, a mobile computer, a laptop computer, a server computer, a tablet computer, a network device, a household appliance or any other suitable computing device. Although only some servers are shown, any applicable number, e.g., thousands of servers may be used according to embodiments of the invention.

Client computing devices 135 and 145 may be any computing device using, utilizing or otherwise associated with a service provided by a server, e.g., by servers 115 and/or 125. For example, client computing devices 135 and 145 may be or may include, for example, a personal computer, a desktop computer, a mobile computer, a laptop computer, a notebook computer, a terminal, a workstation, a server computer, a Personal Digital Assistant (PDA) device, a tablet computer, a network device, a mobile phone, a smartphone, a household appliance or any other suitable computing device. It will be recognized that embodiments of the invention are not limited by the nature, type, number or other aspects of servers 115 and/or 125 nor are embodiments of the invention limited by nature, type, number or other aspects of client computing devices 135 and/or 145. Although two client computing devices are shown, any applicable number, e.g., thousands of client computing devices may be used or may be part of embodiments of the invention.

Networks 150 and 160 may comprise, or may be part of a private IP network, the internet, an integrated services digital network (ISDN), frame relay connections, a modem connected to a phone line, a public switched telephone network (PSTN), a public or private data network, a local area network (LAN), a metropolitan area network (MAN), a wide area network (WAN), a wireline or wireless network, a local, regional, or global communication network, a network internal to a computing device, e.g., a bus as known in the art, an enterprise intranet, any combination of the preceding and/or any other suitable communication means. Networks 150 and 160 may be physically located in the same geographical location, e.g., they may be two segments of an intranet in an organization's facility or they may be geographically apart, e.g., in two different, remote sites or locations. Networks 150 and 160 may or may not be of the same or similar architecture, for example, network 150 may be a private IP network while network 160 may be a combination of the internet and a private frame relay network connected to the internet. It will be recognized that embodiments of the invention are not limited by the nature or type of networks 150 and 160 or other aspects related to network 150 and/or 160.

Network device 170 may be any suitable or applicable network device. For example, network device may be or may comprise a firewall, a load balancer, a virtual private network (VPN) device or access point, or a network switch, router or gateway. Network device 170 may perform any applicable tasks or functions required in order to enable computing devices to communicate, e.g., over networks 150 and 160. For example, network device 170 may be or may comprise a network switch enabling client computing device 135 to communicate with server 125. Network device 170 may additionally or alternatively be or comprise a gateway enabling computing devices connected to network 150 (e.g., emulating computing device 110) to communicate with computing devices connected to network 160 (e.g., client computing device 145).

Emulating computing devices 110, 120 and 130 may be any suitable computing devices. For example, computing devices similar to servers 115 or client computing device 135 as described herein. Alternatively or additionally, emulating computing devices 110, 120 and 130 may be or may comprise a chip, an application specific integrated circuit (ASIC), a field programmable gate array (FPGA), a computer blade, e.g., installed in a chassis, a core in a multi-core CPU or any other suitable computing device. Typically but not necessarily, emulating computing devices 110, 120 and 130 may be devices that require limited resources in order to operate or function, for example, a power consumption of these devices may be very low. Although emulating computing devices 120 and 130 are shown as related to server 125 and network device 170 respectively, embodiments of the invention are not limited in this regard. An emulating computing device may be related to or incorporated in client computing device or any suitable device, system, platform or component.

Various configurations of embodiments of the invention are possible. Other than a server in an organization or a server in a datacenter being emulated during applicable periods of time other implementations or configurations are possible. For example, a personal or home computer connected to the family's entertainment set top box may not be accessible, e.g., for playing a movie, if it is in sleep mode or similar state. Such home computer may be emulated during times it is not used by an emulating, low resource device. For example, network behavior, presence or other aspects may be emulated. Such configuration may enable putting a home PC to sleep while maintaining its availability or network presence. Another example may be a home computing device being accessed from a remote location, e.g., accessing a home PC from a work office, accessing an office PC from a mobile device such as a laptop or a smart phone. Again, if the home PC is allowed to assume sleep mode or other low operational state according to the prior art, it may not be remotely accessible. Embodiments of the invention may enable such home PC to enter sleep mode while its network related applications or other aspects are being emulated by an emulating device thus maintain its availability for remote access.

In a typical mode of operation, servers, e.g., servers 115 and/or 125, may perform tasks or functions for remote users, applications or client computing devices, e.g., device 135 or 145 or users operating such devices. Such functions may comprise, for example, executing various applications on behalf of remote users, storing and providing data or otherwise performing or providing various services. Since it may be impossible to determine or predict a time when services provided by a server may be required or generally when communication with a server may be required, servers may be required to continuously maintain a network presence. A network presence of a server may generally refer to an availability and/or accessibility of/to the server over a network. However, there may be periods of time when servers, e.g., servers 115 and 125, are idle, or when services provided by such servers are not required and/or requested by any computing device, application, user or any other entity.

As known in the art, a computing device connected to a network may perform various network related, background functions even when it does not perform or execute a specific function or provide a service. For example, implementations of network protocol stacks may perform maintenance or background tasks. Embodiments of the invention are not limited by the network architecture involved or the parts or components of such architectures. For example, embodiments of the invention may be applicable to network architectures or layers such as asynchronous transfer mode (ATM), frame relay, integrated services digital network (ISDN), transmission control protocol (TCP), internet protocol (IP), fiber optics, ethernet or any combination thereof. For the sake of simplicity and clarity, TCP/IP over ethernet is mainly used in the discussion herein as an example. In the case of TCP, maintenance or background tasks may be, for example, handling keep-alive messages over established connections, listening to well known or other ports, responding to status messages or queries related to selected applications, e.g., directory change command according to common internet file system (CIFS) protocol etc.

According to embodiments of the invention, an emulating device may perform such maintenance or background tasks for, or on behalf of, an emulated device or server thus enabling the emulated computing device to operate in a reduced functionality mode, e.g., sleep, power save, hibernation or other mode. An emulating device may further require minimal resources, e.g., electric power, in order to operate. According to embodiments of the invention, having an emulating device emulate, substitute or replace a computing device while the computing device operates in a reduced functionality mode may enable substantial resource saving, e.g., batteries or other energy resources. For example, a server typically consuming 250 Watts (joules of energy per second) may be emulated by a chip or ASIC only consuming ten (10) or even less Watts. In other embodiments, hundreds of servers may be emulated by a single computing device thus resulting in a substantial reduction of consumption of energy and/or other resources as well as reduced heat dissipation. In particular, a substantial reduction of current draw from batteries of a laptop computer (other computing device) may be enabled by embodiments of the invention while maintaining, possibly selective, connectivity or other operational aspects of the laptop or other computing device or application executed thereon.

According to embodiments of the invention, an emulating device, e.g., emulating computing devices 110, 120, 130 or 210 may fully or partially emulate, imitate, substitute, fill in for, or otherwise replace one or more functions, functionalities and/or operational or other aspects of a server or other computing device being emulated. In some embodiments, an emulating device may perform or assume some or all network related activities, functionalities or other aspects of the device being emulated while the emulated device may maintain, perform or continue performing other functionalities. For example, applications originally executing on an emulated computing device may continue executing on the other computing device while the other computing device's network related functionality is being emulated by an emulating device. As further described herein, if or when an application executing on the emulated computing device requires network communication, emulation of the computing device may be terminated.

According to embodiments of the invention, a computing device being emulated by an emulating device may, for example, enter or assume an alternative operational mode or state. For example, an emulated computing device may assume a sleep, power save, stand-by or hibernation mode or otherwise assume a reduced functionality state while being emulated. Alternatively or additionally, while being emulated, specific resources associated with an emulated computing device may selectively be shutdown, halted, or otherwise made to reduce their operational capacity. For example, a hard disk may be put to sleep, its read/write head may be parked, a display may be turned off, a frequency of a clock governing an operation of a CPU, controller and/or chip set may be lowered or wait states may be added between operational states of a component. Some or all applicable components of a computing device being emulated may be caused to operate according to a predefined, typically reduced capacity. Typically, while being emulated, a computing device and/or its components may, possibly as a result of an assumed alternative operational state or mode, consume substantially less power than otherwise. Embodiments of the invention are not limited by the state, mode, or other operational aspects related to a computing device being emulated as described herein. Accordingly, any methods, systems, means or techniques known in the art may be employed in order to alter an operational state of an emulated computing device without departing from the scope of the present invention.

In some embodiments, an emulating computing device may maintain a network presence of a computing device being emulated. For example, an emulating device may control, maintain, or be otherwise associated with network connections originally or otherwise associated with an emulated computing device as described herein. Accordingly, an emulating device may communicate with network devices on behalf of an emulated computing device. For example, an emulating device may send and/or receive data over network connections that were originally established by the emulated computing device.

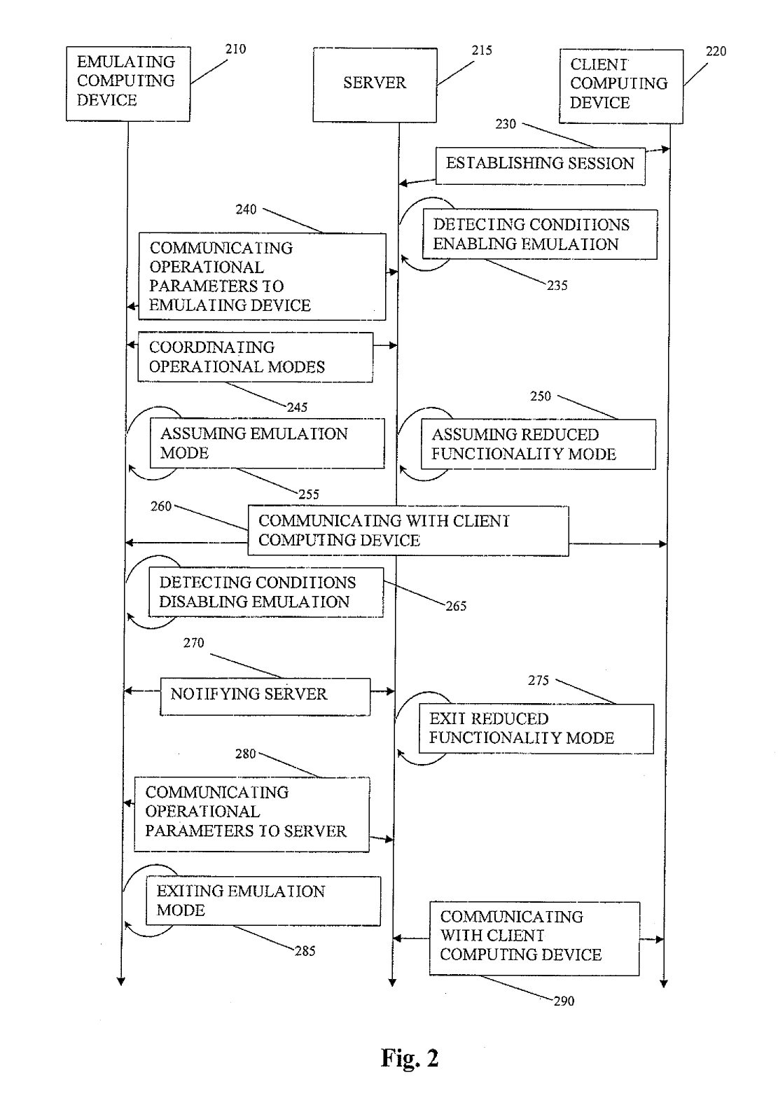

Reference is made to FIG. 2 depicting an exemplary time-event flow according to embodiments of the invention. Emulating computing device 210 may be similar to any one of emulating computing devices 110, 120 and/or 130, server 215 may be similar to servers 115 and/or 125 and client computing device 220 may be similar to client computing devices 135 or 145. It will be noted that although a server 215 is being emulated in this exemplary time-event flow, according to embodiments of the invention, server 215 may be replaced by any applicable computing device (e.g., a laptop) in a similar time-event flow. According to embodiments of the invention and as shown by block 230, a session may be established between server 215 and device 220. For example, a TCP connection may be established between server 215 and device 220. As shown by block 235, the flow may include determining that conditions required for enabling server 215 to be emulated. Such determination may comprise detecting or identifying an emulation condition, e.g., a condition enabling a first computing device to be emulated by a second computing device. For example, it may be determined that conditions for emulating a server are met when a predefined idle time period of the server is detected, accordingly, following commencing of emulation of server 215 by an emulating device, server 215 may be caused to assume a power save or other mode.

In some embodiments, a module, e.g., a software module executed on server 215, may be configured to detect such conditions. Conditions that enable or permit a server to be emulated (and their respective detection) may vary from one server to another or they may vary according to circumstances, e.g., time of day, applications running on the server or any other applicable or available parameters, information, aspects or context. For example, a list of applications that may be executed on server 215 may be provided to a software module that may determine that none of the listed applications is currently executing and accordingly, the server may be emulated. It will be recognized that embodiments of the invention are not limited by the way, method or means to determine that a server may be emulated. Alternatively or additionally, conditions enabling or permitting emulation of a computing device may be detected by a device other than the device to be emulated. For example, emulating device 455 may detect conditions enabling or permitting emulation of server 405 or conditions that otherwise indicate that emulation of server 405 is desirable.

As shown by block 240, operational parameters may be communicated from server 215 to emulating device 210. Operational parameters as referred to herein, may be or may include any relevant or applicable parameters. For example, operational parameters may be network operational parameters, setting parameters, context parameters, state parameters, mode parameters or configuration parameters, data or information. For example, internet protocol (IP) addresses, routing tables, ARP tables, a list of established TCP connections possibly accompanied by their associated transmission control blocks (TCB), a list of ports being listened to (e.g., as defined by TCP and/or user datagram protocol (UDP)) etc. Operational parameters may be or may include any application related information, data or parameters. For example, a state of a specific application, whether predefined messages are expected by the application and so on. Operational parameters may be or may include any setting parameters, configuration parameters and/or state, mode or context parameters, data or information that may be relevant to or used or required by a computing device emulating another computing device. For example, network operational and/or context parameters may be TCP connections information, e.g., any information, data or parameters typically stored in a transmission control block (TCB) used by a TCP implementation as known in the art. A TCB may exist for each TCP connection, a TCB may include parameters such as receive and transmit sequence numbers, receive and transmit window sizes, source and destination IP addresses and port numbers, connection state etc. Accordingly, transferring a TCB from server 215 to emulating device 210 may enable emulating device 210 to emulate server 215 insofar as the relevant TCP connection is concerned. In the exemplary case of TCP/IP, network context information or operational parameters may further include objects such as an address resolution protocol (ARP) table, a routing table and the like. Accordingly, such information or objects may be transferred as shown by block 240.

As shown by block 245, a transition from one operational mode to another of server 215 and emulating device 210 may be coordinated. Such coordination may be required in order to maintain coherency, for example as viewed by client device 220. For example, it may be undesirable for both server 215 and emulating device 210 to attempt to communicate over the session (that may be a TCP connection) established as shown by block 230. Accordingly, in the exemplary case of TCP/IP, coordination or synchronization may be required to ensure that the operational modes of server 215 and device 210 are such that only one of them is actively associated with a TCP connection. Any suitable synchronization or coordination mechanism may be employed. For example, upon completion of communicating network context information or operational parameters as described herein, emulating device 210 may cause server 215 to operate according to a predefined operational mode. For example, emulating device 210 may instruct server 215 to enter or assume a reduced functionality operational mode and upon receiving an acknowledge (ACK) from server 215, may commence emulating server 215 as shown by block 255. Server 215 may enter a reduced functionality operational mode as shown by block 250 immediately after communicating the acknowledge as discussed. Emulating device 210 may perform any other necessary operations. For example, emulating device 210 may cause, e.g., configure, a network device to route communication of data destined to server 215 to emulating device 210.

According to embodiments of the invention, an emulating device may handle, maintain, control or be otherwise associated with any network related aspects that may be associated with an emulated device. For example, while emulating server 215, emulating device may communicate with client computing device 220 over a TCP connection as shown by block 260, for example, over a TCP connection previously established between server 215 and device 220 as shown by block 230. Emulating device may be able to communicate over such TCP connection based on network context, configuration, parameters or other information or operational parameters received from server 215 as described herein. Network context information or operational parameters obtained by emulating device 210 may enable it to communicate over a previously established TCP connection while adhering to any TCP/IP rules, constraints limitations or other aspects, e.g., sequence numbers, connection state, window sizes, maximal transmission unit (MTU) option etc. Accordingly, the fact that rather than server 215 communicating over such TCP connections with client device 220 emulating device is now communicating with device 220 may be transparent to client device 220 and possibly, transparent to other devices on the relevant network.

As shown by block 265, emulating device 210 may detect conditions disabling emulation of server 215. Such condition may generally be referred to as an awake condition requiring an emulated device to wake, e.g., assume or enter a normal operational mode. For example, a request to establish a new TCP connection (reception of a synchronization packet known as SYN packet) may cause emulating device 210 to determine that emulating server 215 may no longer be desirable or that transparent emulation of server 215 may no longer be performed. Various other considerations, limitations, aspects or configuration parameters may control or effect a decision to terminate or continue an emulation of a server. For example, emulating device 210 may be configured to process layer 7 (e.g., application level or layer) information. Accordingly, emulating device 210 may be able to emulate server 215 with regards to a specific application, e.g., respond to a specific application's query etc. Accordingly, upon receiving data or information requiring an involvement of server 215, e.g., information destined to an application associated with, or executing on server 215, emulating device may notify server 215 as shown by block 270. Although not shown in FIG. 2, In some embodiments of the invention, detection of conditions requiring and/or yielding a termination of an emulation of a server may be performed by the server rather than by the emulating device. For example, a module such as server module 412 may be configured such that while server 405 assumes a “sleep mode” or “power save mode” module 412 is still running, possibly maintaining full functionality. Accordingly, server module 412 may be interacted with at any time, even during times server 405 is in sleep or other reduced functionality mode or state. Accordingly, server module 412 may detect conditions requiring restoring full functionality of server 405 or otherwise altering an operational or other state of server 405. For example, server module may detect that a scheduled task has been initiated. Module 412 may determine, possibly by checking a list of tasks known to require network connectivity, that server 405 should be “woken up”, e.g., resume full functionality. In such case, server module 412 may wake server 405 and/or notify emulating device 455 and/or perform any other task it may have been configured to perform upon such event. Other events that may be similarly detected may be hardware or other interrupts detected. For example, an I/O device connected to server 405 may cause module 412 to act as described herein, a wake on LAN (WOL) message received, possibly from emulating device 455 or any other conditions or events. In some embodiments, detection of conditions requiring a termination of an emulation of a server, e.g., server 405 may be performed by the emulating device. For example, emulating device 455 may determine that emulation of server 405 is to be terminated when a specific packet is received from a network. For example, a packet destined to an application residing or executing on server 405 may be received, during a time server 405 is being emulated, by emulating device 455. Upon receiving, and possibly analyzing such network packet, emulating device module 460 may determine that an application executing on server 405 needs to handle the packet and accordingly, server 405 may no longer be emulated. Accordingly, emulating device 455 may interact with module 412 that may, as described herein, be in an operational state enabling it to interact with emulating device 455 even when server 405 is in sleep or other mode. Emulating device 455 may instruct module 412 to wake server 405 or otherwise alter server's 405 operational state. Altering an operational or other state of server 405 may be performed, for example, by causing an interrupt (e.g., a software or hardware interrupt). Any method of altering an operational state of a computing device, e.g., an interrupt, a cold or warm reset, a remote procedure call and the like may be utilized by embodiments of the invention without departing from the scope of the invention.

Possibly upon receiving a notification as shown by block 270, server 215 may exit a reduced functionality mode or any operational mode assumed while being emulated, and enter or assume a normal or other operational mode as shown by block 275. In such mode server 215 may receive network context information or operational parameters communicated by emulating device 210 as shown by block 280. Operational parameters transferred as shown by block 280 may be similar to those transferred as shown by block 240. Though similar, compared with parameters transferred as shown by block 240, parameters transferred as shown by block 280 may reflect network or other activity that took place while server 215 was being emulated, for example, activities involving emulating device 210 and client computing device 220. For example, a state or other aspects of a TCP connection transferred from server 215 to device 210 may have changed, due to sending and/or receiving data over the connection etc. Accordingly, server 210 may update relevant structures, e.g., TCB blocks associated with TCP connections such that communication over existing TCP connections may seamlessly proceed. For example, referring to the flow depicted in FIG. 2, client device 220 may be unaware of the fact that the entity with which it is communicating over a TCP connection has been server 215 during a first period of time, emulating device 210 over a second period of time and server 215 again over a third period of time.

As shown by block 285, emulating of a computing device may be terminated. Such termination may include, as shown by block 280, exiting an emulation mode by the emulating device. For example, emulating device 210 may cease emulating server 215, e.g., handling network connections associated with server 215 etc. As shown by block 290, terminating an emulation may include handling of network connections by the device previously being emulated. For example, TCP connections that may have been handled by emulating device 210 during a time server 215 was emulated may be handled by server 215 upon termination of an emulation. A transfer of control, handling usage or association of network connections from an emulating device back or to another device, e.g., to server 215 may be transparent to other devices, for example, client device that may be unaware of such transfer. Such transparency may be enabled by communicating relevant information from an emulating device to an emulated device.

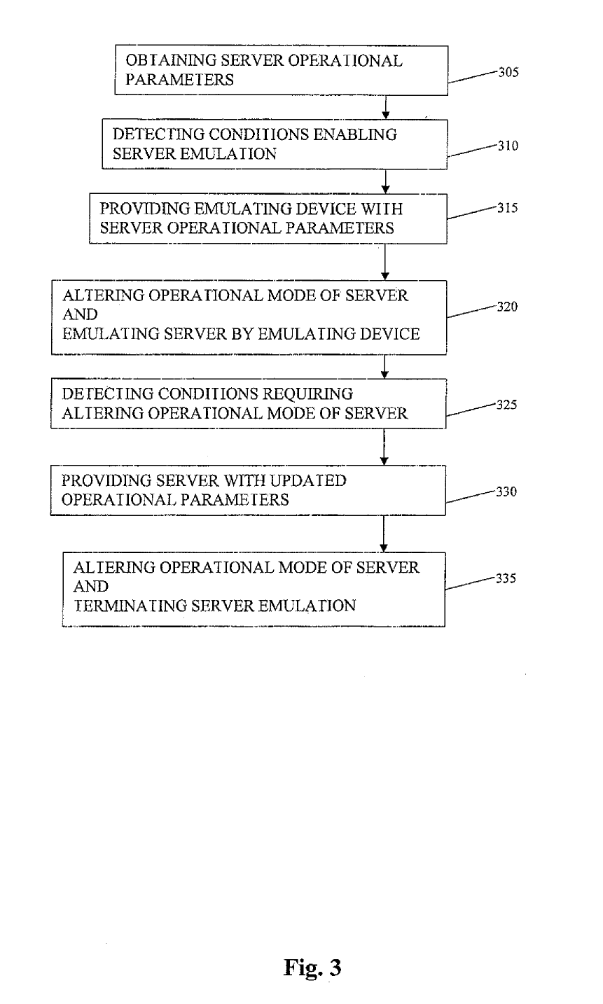

Reference is made to FIG. 3 depicting an exemplary flowchart of emulating a first computing device by a second computing device according to embodiments of the invention. For the sake of simplicity and clarity, an emulated computing device may be referred to as a server herein. As shown by block 305, the flow may include obtaining server operational parameters. As described herein, such operational parameters may enable an emulating device to fully or partially emulate a server in a way transparent to any device, user or application interacting with the emulated server. Accordingly, operational parameters as referred to herein may comprise any parameters, data, information or content relevant to an emulation of a computing device. Operational parameters may be any parameters related to a network functionality. For example, parameters described herein with reference to block 240 in FIG. 2.

According to embodiments of the invention, a special module installed on a server to be emulated may perform obtaining of operational parameters described herein. For example, a filter driver configured to interact with a kernel or other entities of an operating system may be executed on server 215 in FIG. 2 or one of servers 115. Such module may, for example, interact with a TCP/IP protocol stack and obtain any applicable information, e.g., list of active ports, ports being “listened” to, ARP table or routing information etc.

Operational parameters obtained or collected and/or communicated, e.g., between an emulated and an emulating device as described herein may relate to any one of the open systems interconnection (OSI) seven layers of a network architecture as known in the art. Accordingly, operational parameters may include lower layers related information or parameters, e.g., media access control (MAC) addresses, network layer information, e.g., IP addresses or routing information, transport layer parameters, e.g. TCP parameters and application layer or level information.

Application layer information or parameters obtained according to embodiments of the invention may be specific to each relevant application. For example, knowledge of a specific protocol used by a specific application may enable embodiments of the invention to collect or otherwise obtain parameters relevant to such application, in particular, parameters related to communication or network aspects related to such application, and may further enable an emulating device to emulate some of the functions or aspects of such specific application.

As shown by block 310, the flow may include detecting conditions enabling server emulation. Such detection may comprise identifying, observing or detecting an emulation condition, e.g., a condition enabling a first computing device to be emulated by a second computing device. An emulation condition may indicate a suitability of a first computing device to perform a set of emulated network operations of a second computing device. For example, an emulation condition may indicate a condition where by emulating device 110 is suitable for emulating one of servers 115 in FIG. 1. For example, a set of emulated network operations may be performed by emulating device 110 where such set of operations is normally performed by one of servers 115, e.g., when the server operates according to a normal operational mode.

According to embodiments of the invention, conditions enabling server emulation may be related to any operational aspect of the server, e.g., mode or state of an operating system operating the server, a network or other protocol stack and the state or condition of applications executing on the server. For example, it may be determined that a server may be emulated if applications executing on it are idle or otherwise require no interaction with entities external to the server or if relevant information indicates that no interaction with other computing devices is to be expected for a known or unknown period of time. Conditions enabling emulating a server or other computing device may be preconfigured. For example, a configuration parameter may be such that emulation of a server is disabled during a specific time of day, day of week etc. Alternatively, specific conditions, states, modes or other aspects of specific applications may dictate enabling/disabling of emulation. For example, if a specific application executing on a server is known to be currently involved in an ongoing interaction with a user then emulating of the server may be disabled, prohibited or avoided.

As shown by block 315, the flow may include providing an emulating device with server operational communication, network or other parameters. Parameters collected as described herein and/or any other information, data or parameters relevant to an emulation of a server may be provided to a device configured to emulate the server. For example, a module installed on a server and configured to collect operational parameters as described herein may communicate, e.g., over a network, any or all of the parameters obtained as described. Providing operational or other parameters to an emulating device may be performed in any applicable way. For example, an emulating device may be directly connected to an emulated server, e.g., over a peripheral component interconnect (PCI) or other bus. Alternatively, as described herein, an emulating device may reside inside an emulated server or computing device, accordingly, providing operational parameters to the emulating device may comprise storing them in a predefined location in a memory accessible to the module collecting the operational parameters and the emulating device.

While techniques known in the art, e.g., virtualization, may move or relocate an application or a virtual server from one physical machine or device to another, embodiments of the invention may differ at least insofar as they may selectively identify, collect or obtain and communicate network parameters, information and/or context from an emulated device to an emulating device. For example, rather than or in addition to communicating a memory snapshot or other structures or objects, embodiments of the invention may obtain and communicate a collection of parameters specifically related to a network functionality and/or context related to a device to be emulated to an emulating device. Such communicated parameters may enable an emulating device to perform some or all network related functionalities or aspects of the relevant emulated device.

As shown by block 320, the flow may include altering the operational mode of a server and emulating the server's communications, network or other aspects by an emulating device. For example, the emulated server may be put to sleep or assume a power save mode as known in the art or otherwise assume an operational state or mode that comprises reduced functionality and possibly, reduced power consumption or limited consumption of other resources. Emulation of a first computing device by a second computing device may be performed such that any related network devices, applications, users or other entities are unaware of such emulation being performed, otherwise phrased, emulation of a first device by a second device may be transparent to other devices. For example, a remote computer communicating with a server during a first period of time may be unaware it is communicate with an emulating device during a second period of time, where the server is being emulated by the emulating device during such second period of time. For example, an application on client computing device 135 may interact with server 125 during a first period of time when server 125 is not being emulated. Such application may interact with emulating device 120 during a second period of time when server 125 is being emulated by device 120 and again with server 125 during a third period of time when server 125 is no longer being emulated. Accordingly, emulation of a server may be transparent to other devices associated with an emulation server.

Emulating a server may comprise performing configuration or other tasks related to any device operationally or otherwise associated with the emulated server. For example, referring to FIG. 1, if emulating computing device 110 is to emulate server 125 then network device 170 in FIG. 1 may be configured to route or direct traffic destined for server 125 to emulating device 110. According to embodiments of the invention, upon commencing emulation of a server an emulating device, e.g., device 110, may broadcast or otherwise communicate a gratuitous ARP. As known in the art, a gratuitous ARP associates an IP address with a MAC address. A gratuitous ARP causes a receiving device to update its ARP table, a table which is used for translating IP (network) addresses to MAC (physical layer) addresses. Accordingly, an emulating device may associate an IP address of an emulated server with its own MAC address, thus causing traffic destined to the server to reach the emulating device rather than the server.

While emulating a server, e.g., emulating a server's network or communication behavior or other aspects, an emulating device may perform any task, e.g., network related task, that would typically or otherwise be performed by the emulated server. For example, maintaining TCP connections by sending and/or responding to keep-alive messages or receiving and sending application specific messages. For example, a protocol adhered to by an application may define a message enabling users or applications to probe or query the application in order to determine if a state, context or other aspects relevant to the application have changed. According to embodiments of the invention, an emulating device may reply to such message without involving the application thus enabling the server to remain in sleep mode or any other mode or state assumed while being emulated.

As discussed herein, routing information may be part of the information obtained and provided to an emulating device. Provided with routing information, an emulating device may cause data packets sent on behalf of an emulated server to traverse the same network path that would have been traversed had such packets originated at the emulated server. For example, source routing may be used by an emulating device to route outgoing traffic according to a routing table or routing information related to an emulated server. As described herein, a single emulating device may emulate a number of servers or computing devices. Accordingly, for each egress packet, an emulating device may examine the relevant routing structure, e.g., the one associated with the server associated with the packet, and set the source routing information in the packet according to the routing information of the specific server associated with the packet. Such mechanism may cause traffic over a network to be unaffected by the emulation of servers attached to the network.

Any other operational or other aspects of one or more emulated servers may be performed or emulated by an emulating device. For example, based on operational parameters provided to an emulated device TCP connection may be fully emulated, e.g., proper time stamps may be added to communications over selected connections, parameters or options such as maximum transmission unit (MTU), maximum window size etc. may be implemented according to their implementation, state or other relevant aspects on the emulated server. Accordingly, a device communicating with an emulating device may be unaware of, or indifferent to the emulation being performed. As described herein, an emulating device may emulate any number of devices, for example, a single emulating device in a datacenter may emulate hundreds or thousands of servers, thus dramatically reducing power consumption and costs. An emulating device may emulate any number of devices, e.g., servers by specifically emulating each of the emulated devices' behavior. For example, a possibly different MTU, receive and transmit window sizes or other TCP parameters of each emulated server may be adhered to when emulating, or communicating with remote devices on behalf of the specific emulated server. According to embodiments of the invention, a structure, entry in a table or object representing the network context, parameters or aspects of each emulated server may be maintained and used by the emulating device in order to adequately emulate the network behavior, presence or other aspects of each server or device being emulated.

As shown by block 325, the flow may include detecting conditions requiring altering an operational mode of a server. Such condition may generally be referred to as an awake condition requiring an emulated device to wake, e.g., assume or enter a normal operational mode. According to embodiments of the invention, when an awake or other conditions described herein are met or detected, an emulation of a server may be terminated. Such conditions may be, for example, detecting a request for a service that may be provided by an emulated server, detecting an attempt to open a new network connection to the server, e.g., a reception of a TCP SYN packet. Other conditions may be a reception of a packet containing information that needs handling by an application executing on the emulated server. As discussed herein, specific messages or packets, even ones destined to a specific applications executing on an emulated server, may be handled by the emulating device. However, in case a packet received by the emulating device contains information that the emulating device is unable, unauthorized or otherwise incapable of handling, the emulating device may determine that emulation of the relevant server is to be terminated. As described herein, conditions for terminating an emulation may be related to detected events or received information, e.g., packets received from a network, or they may be related to various other events or aspects. For example, a user may cause an emulation of a server to be terminated by interacting with an emulating device and further instructing it to terminate an emulation of a specific server or a predefined group of servers. Alternatively, configuration parameters may dictate or define conditions for a termination of an emulation of a server. For example, an emulating device may be configured to terminate or avoid an emulation of a server during preconfigured hours, days etc. Other parameters, criteria, rules or thresholds may be used, for example, an emulating device may be configured to terminate an emulation of a server after a predefined period of time during which the server was emulated has elapsed, if a predefined number of predefined messages has been received, a predefined number of connections has been in an established state for a predefined time period etc. Other conditions or criteria for terminating an emulation of a device may be a reset of the emulated device, an interrupt received from an I/O device connected to the emulated device, a hardware or software timer expiration or interrupt etc. It will be noted that an emulating device may be in operational connection and/or communication with the relevant emulated device. For example, a module executing on the emulated device may update the emulating device regarding any conditions, events or relevant states related to the emulated device thus enable the emulating device to determine, possibly based on events related to the emulated device that emulation is to be terminated.

According to embodiments of the invention, an emulated server may cause or trigger a termination of an emulation. For example, by detecting a request of an application executing on the server to communicate over a network. For example, upon detecting that an application executing on the server needs to interact with a user or other application, the server may terminate the emulation. Any conditions requiring the server to regain control of network connections controlled by an emulating device may cause the server to terminate the emulation. Any applicable conditions, configured rules, criteria or events may cause a server being emulated to trigger a termination of its emulation. For example, detecting user interaction with the server, e.g., a local keyboards key being pressed or a connected point and click device being used may be cause the server to terminate its emulation. Any other applicable events, e.g., a hardware or software timer expiration may generate, trigger, initiate or otherwise cause a termination of an emulation of a server or other computing device. Another exemplary event that may cause a termination of an emulation of a server may be a reset, shutdown or power up or down of a server. In such case the server may cause a termination of its emulation as part of a shutdown procedure or as part of its boot or power up procedure.

As shown by block 330, the flow may include providing an emulated server with operational parameters, e.g., network or communication related parameters. For example, operational parameters may be communicated from an emulating device to an emulated server, e.g., as shown by block 280 of FIG. 2. According to embodiments of the invention, while emulating a server, an emulating device may update any relevant information related to operational aspects of the server. For example, sequence numbers and states of TCP connections may be recorded, or any other information typically found in a TCB described herein may be logged or stored. Such information, data or parameters may be provided to an emulated server. Providing an emulated server with such parameters may enable an emulated server that may have been operating in a reduced functionality mode, e.g., sleep or power save mode, to resume full operational mode or assume another, alternative or different operational mode. Any data, information, parameters, rules, thresholds, criteria, settings, configurations or context that may be required by a server in order to change its operational mode or state may be provided as shown by block 330.

As shown by block 335, a server may alter its operational mode, e.g., switch from sleep or power save mode to full operational mode. As further shown, an emulating device may cease from emulating a server at such point. Any configurations required in order to enable a server to function in non-emulated state mode or fashion may be affected by the server, by the emulating device or by both. For example, gratuitous ARP messages may be broadcasted in order to cause devices connected to a network to correctly update their respective ARP tables. Routers, gateways or other network devices may be configured in order to reflect that a server is no longer being emulated.

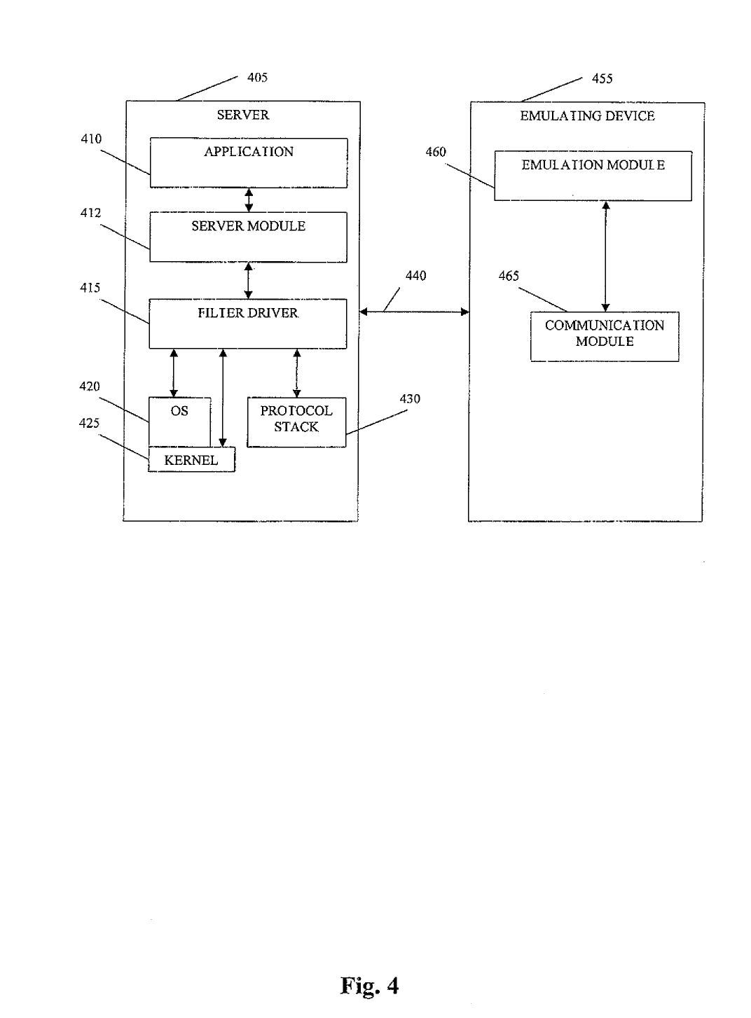

Reference is made to FIG. 4 showing some exemplary components of an exemplary system according to embodiments of the present invention. Server 405 may be a server as described herein, e.g., server 405 may be similar to servers 115 or server 125 in FIG. 1. It will be noted that although a single server is shown, any number of such servers may be part of embodiments of the invention. For example, a single emulating device 455 may emulate a large number of servers such as server 405. Application 410 may be any application executing on server 405, e.g., mail server application, database or database interface application etc. Server module 412 may be a software, firmware and/or hardware module or a combination thereof. Module 412 may perform any functionalities required in order to facilitate an emulation of server 405 as described herein. Such functionalities may be communicating with emulating device 455, collecting and processing information, e.g., from filter driver 415 or application 410 etc. Server module 412 may interact, communicate or exchange information with various entities. For example, module 412 may interact with or obtain information from kernel 425, OS 420, a registry maintained by OS 420, protocol stack 430, or any application running on server 405 or on any other computing device. For example, server module 412 may interact with an emulating computing device. For example, a server module 412 on any one of servers 115 shown in FIG. 1 may interact with some or all of emulating computing devices 120, 130, or 110.

Module 412 may interact with OS 420 and obtain or receive any relevant information from OS 420. Such information may be a list, state or status of applications executing on server 405. Information related to applications executing or scheduled to execute on server 405 may enable embodiments of the invention to determine whether and/or how server 405 may be emulated by an emulating device. For example, if a specific application, e.g., a mail application, known to require network activity is currently executing then it may be determined that emulation of server 405 is currently undesirable or impossible. It will be noted that an operational state of applications executing on server 405 may be a parameter upon which a decision to emulate server 405 may be based. For example, although a specific application may be executing, it may be determined that its current state is such that emulation of the relevant server may still be performed as the application may require no network activity or that activity related to the application may be performed by an emulating device. For example, if the network related activity of an application executing on server 405 is receiving, acknowledging or generating a periodic “keep alive” message then server 405 may be emulated by emulating device 455. Accordingly, emulating device may handle such “keep alive” messages on behalf or instead of server 405 and/or applications executing on server 405.

A module such as server module 412 may interact with kernel 425 to obtain various parameters or information that may be used in order to determine whether and/or how server 405 may be emulated as described herein. For example, internal parameters related to OS 420 may be obtained. Such internal parameters or information may not be related to a specific application or user but to aspects such as a state of the operating system, services currently running etc. Other related aspects may be kernel mode operations, processes and the like that may be running, scheduled to run etc. For example, if a kernel level operation that requires network communication is currently running or is scheduled to execute then it may be determined that emulating server 405 may be undesirable and may, for example, be delayed till conditions are such that emulation is possible, desirable or permitted.

Other entities, modules, and the like that may be interacted with by server module 412 may be a protocol stack, e.g., a TCP protocol stack implementation, a registry, e.g., a registry of a Windows® operating system as known in the art. Interacting with a TCP protocol stack may enable server module to determine the state, level, scope or other parameters related to network activity related to server 405. For example, it may be determined if and/or which applications or connections are currently involved in network activity and/or the type or nature of such activity. Such determination may be based on monitoring network connections that are active, being listened to etc. Module 412 may interact with any other relevant module or entity on server 405 in order to obtain any relevant information, in particular, information relevant to network activity or other aspects.

Module 412 may be installed on server 405 any time after server 405 has been operative or module 412 may come pre-installed, e.g., as part of an installation of an operating system. For example, server module 412 and/or filter driver 415 may be part of an operating system operating server 405. Filter driver 415 may, as known in the art, interact with various components of server 405. For example, as shown, filter driver 415 may interact with operating system (OS) 420, kernel 425 and/or protocol stack 430. Filter driver 415 may extract, receive or otherwise obtain any information from OS 420, kernel 425, protocol stack 430 or any other module, application or program on server 405. As known in the art, filter driver 415 may intercept any transaction from and/or between the entities listed above or any other entity and may further provide information, data or parameters thus obtained to, for example, server module 412. In some embodiments, filter driver 415 may be part of server module 412. It will be recognized that the configuration depicted in FIG. 4 may be an exemplary embodiment and functionalities described herein may be implemented in various other implementations without departing from the scope of the invention.

OS 420 may be any commercial or other OS as known in the art. Kernel 425 may be the kernel of OS 420 as known in the art. Protocol stack 430 may be any applicable protocol stack as known in the art, e.g., a TCP/IP protocol stack, possibly adapted to run, for example, over ethernet physical and data layers.

Emulating device 455 may be an emulating computing device as described herein. For example, emulating device 455 may be similar to any one of emulating devices 110, 120 and/or 130 shown in FIG. 1. Emulating module 460 may be a software, firmware and/or hardware module or a combination thereof. Module 460 may perform any functionalities required in order to facilitate an emulation of server 405 by device 455 as described herein. Such functionalities may be communicating with server 405, for example via communication module 465, collecting and processing information, e.g., information pertaining to protocol connections, applications' state etc. Module 460 may further perform any operation required in order to emulate server 405, e.g., receive, process and transmit network packets, exchange information with users, applications and/or devices on behalf of server 405 etc. Communication module 465 may be any suitable module enabling emulating device 455 to communicate with any applicable entity, e.g., a management application, a user, remote computing devices etc. Module 465 may be or may implement a web server as known in the art thus enabling hyper text transfer protocol (HTTP) communication with, or web-based management of, emulating device 455. As shown by arrow 440, server 405 and emulating device 455 may communicate, for example, over a wireless or wired network, e.g., networks 150 and/or 160 in FIG. 1.

According to embodiments of the invention, various configurations are possible. For example, in a first configuration, emulating device 455 may be a separate device or otherwise independent on a specific device in order to operate. For example, emulating device 455 may be similar to emulating device 110 in FIG. 1 and may be a computing device that operates or functions independently of any other computing device while server 405 may be one or more servers such as servers 115 in FIG. 1. Such configuration, where a single emulating device may emulate a plurality of servers or computing devices may be referred to as a one to many (OM) configuration. In another embodiment, emulating device 455 may be installed inside, or be otherwise part of, server 405. For example as shown by emulating device 120 and server 125 in FIG. 1. In such configuration, an emulating device may be installed or incorporated in, or be part of a server. For example, emulating device 455 may be a chip or ASIC installed on a NIC or CPU core of server 405. Such configurations, where an emulating device may only emulate one, possibly specific server or computing device may be referred to as a “one on one” or “one to one” (00) configuration. In yet another configuration, emulating device 455 may be installed in a network device. For example as shown by emulating device 130 and network device 170. In such configuration, an emulating device installed in a network device may emulate any one or more servers or computing devices connected to a network accessible by the network device. For example, emulating device 130 may emulate servers 115 and/or server 125.

According to embodiments of the invention, a single emulating device may simultaneously emulate any applicable number of servers or computing devices. Any operations, procedures, communicated messages etc. described herein with relation to an emulation of a server by an emulating device may be performed for each emulated server, possibly independently from other procedures, operations or messages exchanged regarding other simulated servers. for example, emulating device 110 may emulate all or some of servers 115.

According to embodiments of the invention, a high availability (HA), load sharing or other configurations are possible. In a HA configuration, two or more emulating devices may share data, information, parameters, rules, thresholds, criteria, settings, configurations, context or any other aspects pertaining to an emulation of one or more computing devices. In such configuration, a first emulating device may be designated as the active emulating device while other emulating devices may be designated as a backup or redundant emulating devices. In case an active emulating device fails, a backup emulating device may step-in or otherwise replace the failing device. While typically replacement of a failing emulating device may be automatic as described herein, such replacement may be manual, e.g., an administrator or other user may interact, possibly with modules 460, via communication modules 465 of the relevant emulating devices and instruct them to perform tasks needed in order to facilitate a transfer of emulation from a first to a second emulating device. Alternatively, such transfer may be automatic. Various protocols may be implemented by a number of emulating devices in order to enable backup, high availability or redundancy. For example, a customized router redundancy protocol (RRP) known in the art may be adhered to, supported or otherwise implemented by a number of emulating devices. Such configuration may enable a number of emulating devices to provide high availability or redundancy as known in the art. For example, a failing emulating device may be automatically and seamlessly replaced by a backup emulating device.

While an emulating module may be installed inside a server or computing device that is to be emulated, an emulating device or module may be external to the server or computing device that is to be emulated. For example, an emulating device may be connected to a network and may, accordingly, emulate any computing device operatively connected to such network. An administrator may configure, e.g., associate a server and/or an emulating device with other devices thus determine which emulating device is to emulate which server. For example, emulating device 110 and a specific one of servers 115 may be configured such that emulating device 110 will emulate the specific one of servers 115, alternatively or additionally, emulating device 120, that is internal to server 125 may, by default, emulate server 125 but may, in addition, emulate one of servers 115. Any applicable configuration may enable any emulating device or module to emulate one or more servers or computing devices.

Various messages may be communicated between and/or by server 405 and emulating device 455. For example, a protocol adhered to by server 405 and device 455 may define a message format comprising the following fields: a message type or op-code, an identification of the emulated device (server) and message parameters. For example, an op-code or message type may be one of: a reset of server, wake (e.g., exit sleep mode), start emulation mode etc. An identifier of an emulated device may serve or enable an emulating device emulating a number of servers to identify the server associated with the message. An exemplary identifier may be a unique identifier associated with a NIC, e.g., the MAC address. Parameters included in a message may be any relevant parameters, for example, operational parameters described herein and communicated between an emulating and emulated device.

The following exemplary functions, tasks or operations may be performed by server module 412. Server module 412 may monitor any relevant activities, events, flows or other aspects pertaining to the operation and configuration of server 405. Aspects monitored by module 412 may relate to software, logic, hardware or any applicable aspects. For example, a change in hardware configuration, e.g., replacement or addition of a NIC to server 405 may be detected by module 412. Connections states, modes and or other aspects may be monitored, recorded and/or logged by module 412. Module 412 may further analyze any obtained information and may determine, according to analyzed information, a time when server 405 may be emulated and a method, level, degree, extent or way of emulation. As shown, server module may interact with an OS, an OS kernel, a protocol stack and/or applications on server 405. Although only some components of server 405 interacted with by module 412 are shown, any applicable component of server 405 may be interacted with by module 412 in order to obtain information or parameters required in order to determine server 405 may be emulated.

Server module 412 may collect any information parameters or other data that may be required by emulating device 455 and, as part of emulating server 405, may communicate any such information to emulating device 455. Upon termination of an emulation of server 405 and as described herein, emulating device 455 may communicate to server 405 any data, information, parameters, rules, thresholds, criteria, settings, configurations or context required in order to enable server 405 to operate according to the operational state assumed after being emulated. For example, information in TCB's of TCP connections, e.g., sequence numbers, expected ACK, connection state, timers etc. may be sent from emulating device 455 to server 405 in order to enable server 405 to resume control of, maintain and/or use such TCP connection. Accordingly, module 412 may receive such parameters and may further provide various components of server 405 with needed information. For example, module 412 may update protocol stack 430 with information pertaining to connections as described above. Module 412 may similarly update or configure OS 420 or application 410 according to received information, for example, regarding states, modes, events and the like.

In some embodiments of the invention, after server 405 has been emulated, module 412 may function as an adaptation layer. For example, a TCP connection that has been transferred to emulating device 455 and then returned to server 405 may have had some bytes or packets sent over it while being emulated by device 455. Accordingly, a difference may exist between the sequence numbers of the last byte sent and/or received by protocol stack 430 and the correct numbers that must be used in order to adhere with the TCP rules. In such case, module 412 may adjust protocol header fields of incoming and/or outgoing (ingress and/or egress) packets, e.g., an offset may be added to or subtracted from sequence number fields in protocol headers, e.g., TCP headers, or a time stamp may be adjusted or otherwise manipulated or a window size parameter may be modified, e.g., according to a window scale parameter received from a remote peer. Any other adaptation or other tasks may be performed by module 412 in order to enable transparency of emulation to various components of server 405 and/or computing devices interacting with server 405. Other exemplary operations may be updating a protocol stack regarding new connections, e.g., connections opened by an emulating device during an emulation period etc.

While server 405 is being emulated, module 412 may monitor any applicable activity, state or aspect of server 405 and may further act when required. For example, module 412, possibly aided by filter driver 415, may block egress or ingress network communication from/to server 405. For example, module 412 may prevent server 405 from sending or receiving ACK packets over TCP network connections. Module 412 may do so in order to prevent duplicate messages, e.g., messages sent by both an emulated server and the respective emulating device.

In order to interact with a protocol stack, module 412 and module 460 may implement a command, procedure or application program interface (API) that may enable manipulations of network connections. For example, the following commands relaying on the well known in the art socket interface may be implemented. For example, SocketListenAdd (IP address)(Port Number) enabling commanding a listen to be performed on a socket identified by the provided IP address and port number, SocketListenDel enabling stopping of a listen on an identified socket, SocketListenShow enabling a listing of relevant sockets, SocketActiveAdd (IP address)(Port Number) enabling adding an active socket to a protocol stack and SocketStop (socket id) enabling stopping an interaction with a socket (and associated connection). Such exemplary commands may be used in order to interact with a protocol stack in order to manage handling of connections by such protocol stack. Such commands may enable module 412 to cause protocol stack 430 to stop handling connections while server 405 is being emulated and may also enable module 412 to cause protocol stack 430 to regain control of connections when server 405 is no longer being emulated. similarly, such commands may be used by module 460 on emulating device 455 when interacting with the local protocol stack (not shown). For example, ports listened to by server 405 may be listened to by emulating device 455 by having module 460 using SocketListenAdd.

Module 412 may update emulating device, e.g., emulation module 460 regarding any meaningful events. for example, in case server 405 is shutdown or being reset module 412 may update module 460 either during a shutdown procedure or when server 405 is operational, e.g., after a restart. When server 405 is rebooted or otherwise becomes operational, module 412 may obtain, from local storage, from emulating device 455 or from another source relevant information or parameters determining aspects of emulation. For example, a time during which server 405 is to be idle before emulation of it will be triggered. Such configuration parameters may be stored on any applicable device or media. For example, emulating device 455 may store such configuration parameters and may, based on an identification parameter in a message received locate the relevant parameters and send them to server 405.

Emulation module may receive a “sleep” message from server 405 notifying it that server 405 is ready to be emulated. Such message may include all information required by emulating device 455 in order to emulate server 405. Accordingly, module 460 may use such information as described herein, e.g., update a local protocol stack regarding network connections being transferred from server 405 to device 455. Module 460 may perform monitoring and recording of various information, parameters or aspects of network and/or other activity related to server 405 in a way similar to that described herein with respect to module 412. Upon receiving a “wake” message indicating that server 405 needs to assume full or other functional mode, e.g., a “wake” message, module 460 may send all relevant information to server 405, possibly to be received by module 412 on the server. Such relevant information may include any data or parameters as described herein, pertaining to any aspect of operation of the server. For example, updated information pertaining to network connections may be communicated. Such information may include any data or parameters required in order to enable a seamless transition of control of network connections and/or other operational aspects from an emulating device, e.g., device 455 to an emulated server, e.g., server 405.

While emulating device 455 emulates server 405, module 460 may analyze any received information in order to determine if it can handle it by itself or if server 405 needs to be awakened in order to handle received information or detected event. For example, a request for opening a new TCP connection may cause module 460 to determine that server 405 needs to be brought back to full or other operational mode. Other events that may cause a termination of an emulation of server 405 may be application specific events or messages as described herein. Module 460 may be configured to handle various events, messages or received information without involving server 405. For example, module 460 may be configured to handle a specific set of messages pertaining to a specific applications, e.g., reply to a status inquiry. Accordingly, when a message or event is detected by module 460 and such message or event can not be properly handled by module 460, module 460 may send a “wake” message to server 405 thus initiating a termination of emulation of server 405 and further causing server 405 to handle the event.

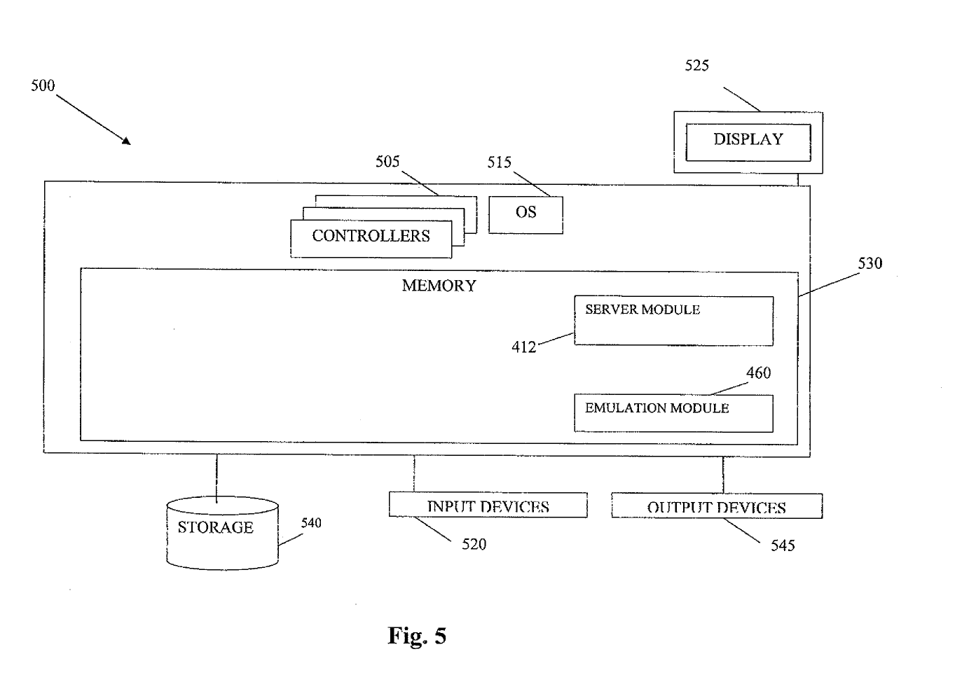

Reference is made to FIG. 5, showing high level block diagram of an exemplary computing device according to embodiments of the present invention. According to embodiments of the invention, servers 115, 125 and 405, client computing devices 135 and 145, emulating computing devices 110, 120, 130 and 455 and/or network device 170 may comprise all or some of the components comprised in computing device 500 as shown and described herein. According to embodiments of the invention, computing device 500 may include a memory 530, a one or more controllers 505 that may be, for example, one or more central processing units (CPU) processors and/or special controllers, a monitor or display 525, a storage device 540, an operating system 515, a one or more input devices 520 and a one or more output devices 545.

According to embodiments of the invention, storage device 540 may be any suitable storage device, e.g., a hard disk or a universal serial bus (USB) storage device, input devices 520 may include a mouse, a keyboard or any suitable input devices and output devices 545 may include one or more displays, speakers and/or any other suitable output devices. According to embodiments of the invention, various programs, applications, scripts or any executable code may be loaded into memory 530 and may further be executed by controller 505. For example, a software module implementing any one or more of server module 412, filter driver 415, emulation module 460 and/or communication module 465 may be loaded into memory 530 and may be executed by controller 505 under operating system 515.

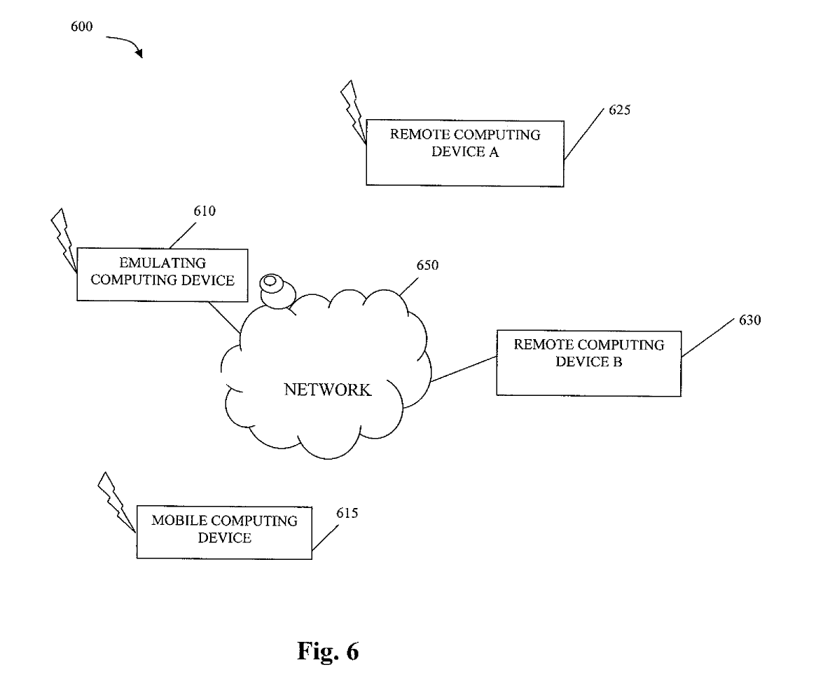

Reference is made to FIG. 6 that shows an exemplary system 600 that may be used according to embodiments of the invention. As shown, system 600 may comprise remote computing devices 625 and 630, mobile computing device 615, emulating computing device 610 and network 650. Remote computing devices 625 and 630 may be remote servers, e.g., similar to server 125 shown in FIG. 1. In other embodiments, remote computing devices 625 and 630 may be user devices such as a laptop or notebook computer, a mobile phone, a mobile personal digital assistant (PDA) and the like. Remote computing devices 625 and 630 may be wireless devices and/or wired device. For example, remote device B 630 may be a laptop computer capable of communicating over both wired (e.g., ethernet) connections and wireless infrastructure. For example, computing devices 610, 615, 625 and 630 may be capable of communicating over a Wireless Fidelity (Wi-Fi) connection or network or over a global system for mobile (GSM) network or system. Mobile computing device 615 may be a laptop or notebook computer, a mobile phone, a mobile personal digital assistant (PDA) or any applicable device typically used by a user for executing applications that may interact over a network. Emulating computing device 610 may be similar to emulating device 110 shown in FIG. 1. Emulating computing device 610 may be capable of performing wireless communication, e.g., over Wi-Fi or GSM networks.

Networks 650 may be similar to network 150 shown in FIG. 1. Network 650 may be, comprise or be part of a GSM or Wi-Fi network. Accordingly, network 650 may enable both wired and wireless devices to communicate and/or interact as known in the art, for example, a wired computer may be enabled to interact or communicate with a wireless mobile phone over network 650 that may support both wired and wireless communication as known in the art.

According to embodiments of the invention, parameters or other data may be collected on computing device 615 as described herein. For example, data or parameters such as a state of an application or credentials used by an application may be obtained and/or updated by a special module on computing device 615. Any parameters or information that may be required in order to execute an application (that is normally executed on computing device 615) on emulating device 610 may be collected as described herein. For example, TCP ports listened to, existing TCP connections and their associated TCBs, names or other identifiers used by emulating device 610 to masquerade itself as emulated device 615 (for example NetBIOS names). Other parameters, structures or data may be timers or timer values associated with periodic, scheduled or other jobs or tasks that may be required to be executed on the emulated device, and may therefore require the wake of the emulated device. For example, in the case of a mail client application being emulated, the parameters may be the name or IP address of the mail server, a user name and password (one or more) of the user or users of the emulated device. The emulating device may use these parameters to periodically poll the mail server to determine a new message has arrived for the emulated computing device, which in turn may require the wake of emulated device 615.

Upon detecting conditions enabling emulating device 610 to emulate mobile computing device 615, any parameters or information relevant to an application that is to be emulated may be communicated to emulating device 610 from computing device 615. Such communication may be over a wired network or over a wireless network. For example, mobile computing device 615 may transfer parameters to emulating computing device over a Wi-Fi network or over a LAN as described herein. Emulating computing device may perform a selected set of tasks or functionalities related to a specific one or more applications. For example, emulating computing device 610 may perform polling of a server on behalf of an application, acknowledge receipt of messages on behalf of an application or it may process messages destined to an application and determine an action based on such processing. For example, emulating computing device may periodically poll a mail server to determine whether new mail has arrived at the server. For example, emulating computing device 610 may be provided with a mail server's internet protocol (IP) address and a port number, a user name and an associated password, and use such parameters to generate SMTP messages and send such messages to a mail server in order to check for arrival of new mail. In cases where secure sockets layer (SSL) connections are required, emulating computing device 610 may be provided with credentials or other that may be necessary in establishing and maintaining such secured connections. Such credentials may be stored by emulating computing device 610 and may be used as known in the art. Any parameters required in order to enable an emulating device to perform one or more parts of an application may be provided to an emulating device as described herein.

As known in the art, parameters such as SSL credentials may expire or they may be dynamically modified, e.g., while a connection or session are established, alive or active. In some embodiments, an emulating device, e.g., emulating computing device 610, may perform any control, maintenance or management operations with respect to parameters, configuration data or any applicable information related to an application while the application, or part thereof, is executed on the emulating device. For example, emulating computing device 610 may implement any functionality required in order to maintain, replace, modify or otherwise manage parameters such as credentials, history lists and the like. According to embodiments of the invention, parameters related to an application and modified by an emulating device may be communicated to an emulated device when an emulation is to be terminated. Accordingly, coherence or any relevant aspect of any dynamic parameters may be adequately maintained and communicated such that a transfer of an execution of an application from an emulated device to an emulating device and a transfer back to the emulated device may be seamless with respect to an operation of the application. In some embodiments, devices, applications or users may not be able to realize that in fact, they communicate with an application executing on an emulating device during some of the time and with an application executing on the actual device during other times, for example, during a single session.

According to embodiments of the invention, various rules, criteria or configuration parameters may define conditions or events that will cause a termination of executing an application or part thereof on an emulating device. For example, a rule may define that upon indication of arrival of new mail at a mail server, an execution of a mail client application on an emulating device is to be terminated. Accordingly, parameters related to the mail client application (possibly created, updated or modified by the emulating device), may be sent to the emulated device and, provided with updated or up to date parameters, the mail client application may commence execution on the previously emulated device, may receive the new mail from the mail server, alert a user of arrival of new mail, and present the new mail. Accordingly, a user of a laptop computer may extend battery life of the computer by putting it to sleep knowing that he or she does not sacrifice an online operational mode by doing so. Likewise, chat applications or part thereof executed on an emulating device may enable users to maintain their online mode or aspects, e.g., be alerted of a arrival of a new messages, even though their respective devices may be in stand-by mode during extended periods of times.

Selecting to execute an application on an emulating device may be according to any criteria, rule or applicable aspect. In some embodiments, even though a computing device may not be made to assume low power or low functionality operational modes, execution of some of the applications normally executing on the computing device may be transferred to an emulating device. For example, memory, CPU load or other considerations may make it desirable to transfer execution an application from a computing device to an emulating computing device. For example, an application that occupies a large portion of a server's memory may most of the time perform periodic polls of a remote server. In such case, it may be desirable to transfer execution of the polling to an emulating device and remove the application from the server's memory. Upon detection of an event that requires the application to execute, it may be loaded back into the server's memory, be provided with updated information and parameters from the emulating device as described herein and perform required operations, unaffected by the fact that it was emulated during a previous period of time. In some embodiments, selecting to transfer execution of applications or part thereof, to an emulating device, may be according to required response time. For example, execution of a first, low priority, non real time application may be transferred to an emulating device while execution of a second, high priority, real time application that requires full operational capacity at all times may not be transferred to the emulating device.

In some embodiments, a number of emulating devices may emulate a respective number of applications associated with one or more devices. In other embodiments, an emulating device may perform a plurality of operations, according to a respective plurality of functionality parameters related to a respective plurality of applications normally executed on a respective plurality of computing devices. For example, execution of a mail client application associated with a user's computer may be done by a first emulating device while execution of a VoIP application may be done on another emulating device. For example, considerations such as network bandwidth or proximity to a server may dictate a configuration that distributes execution of applications or parts thereof over emulating devices. In some cases, a number of emulating devices may execute a respective number of applications associated with a single emulated device such that while the emulated device is in sleep mode, a number of emulating devices execute a respective number of applications or parts of applications on its behalf. In such case, any one of the emulating devices may wake the emulated device as described herein. Upon waking an emulated device by one of the emulating devices, execution of all applications associated with the emulated device (that may be performed by a number of emulating devices) may be returned or transferred to the emulated device. In other embodiments, execution of selected applications may be left on emulating devices even when the emulated device has assumed full or normal operational mode. Configurations and execution related to scenarios described herein may be performed by a management module that may be or may be similar to server module 412.

Waking up an emulated computing device as part of terminating an emulation as described herein may be performed over a wireless network or infrastructure. For example, wireless multimedia extensions packets may be used wake a device using Wi-Fi or using wake on wireless LAN (WoWLAN) as known in the art. For example, emulating computing device 610 may wake emulated mobile computing device 615 using WoWLAN. Similarly, GSM Wake as known in the art may be used over a cellular network, e.g., emulating computing device 610 may wake emulated mobile device 615 via a cellular network.

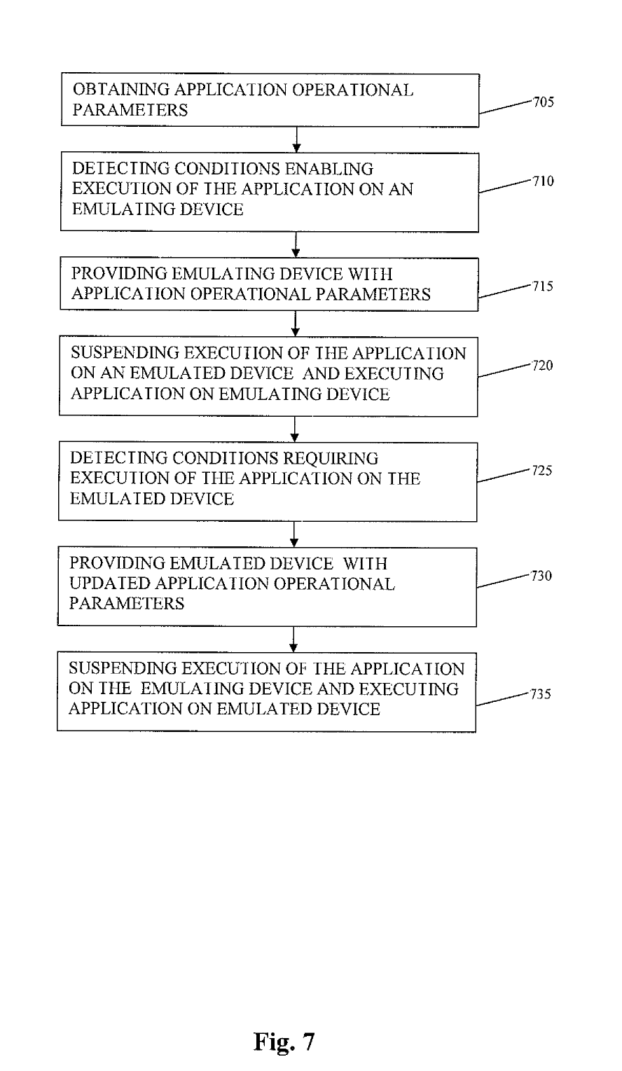

Reference is made to FIG. 7 that shows a flowchart diagram illustrating an exemplary flow according to some embodiments of the present invention. As shown by block 705, the flow may include obtaining application operational parameters. For example, one or more application program interfaces (APIs), plugins or kernel level modules as known in the art may be used to extract, receive or otherwise obtain parameters from an application. Parameters such as application state, application's credentials, associated connections and the like may all be collected, exchanged between emulating and emulated devices, processed and/or stored. Collecting parameters may be performed continuously such that updated parameters are maintained by and/or available to embodiments of the invention. Accordingly, transferring execution of an application to an emulating device may be performed very quickly and by very short notice. In some embodiments, upon determining that emulation may commence or that execution of an application may be transferred to an emulating device, parameters related to applications may be obtained and provided to an emulating device as described herein.

As shown by block 710, the flow may include detecting conditions enabling execution of an application on an emulating device. According to embodiments of the invention, detecting an emulation condition may comprise detecting a condition indicating suitability of an emulating device to execute at least one operation related to an application which is executed on an emulated device. In some embodiments, conditions enabling execution of the application on an emulating device may be similar to those described herein with respect to emulating a device, e.g., conditions enabling the emulated device to assume a reduced operational mode and as further discussed herein. In other cases, such conditions may be application specific or they may relate to other aspects, e.g., resources such as network capacity or bandwidth, memory capacity or availability etc. Any applicable conditions or parameters may be taken into account or consideration when determining whether execution of an application is to be transferred to an emulating device.

As shown by block 715, the flow may include providing an emulating device with an application's operational or functionality parameters. According to embodiments of the invention, providing operational or functional parameters may comprise communicating at least one functionality or operational parameter associated with the application from a first computing device that is executing the application to a second computing device that is to perform at least part of the application, e.g., when the first computing device is to assume sleep or stand-by mode. For example, credentials, connections information, passwords, a servers IP address and a remote application's port number or similar parameters may all be provided to an emulating device such that any state, context or other operational aspects of an application may be observed and/or maintained when its execution is transferred to an emulating device. Other operational or functional parameters that may be provided to an emulating device (e.g., by the emulated device) may be user names and associated passwords (e.g., as required in order to interact with a mail server), applications states, applications configuration parameters, remote devices addresses (e.g., IP addresses), protocol ports and associated applications (e.g., a mail application and an associated TCP port), domain name servers (DNS) parameters as known in the art, internet control message protocol,(ICMP) related parameters, NetBIOS related parameters and/or any other information or data required in order to emulate a device or an application over a network. It will be understood that the above listed exemplary operational and/or functional parameters, data or information may likewise be provided, possibly after being modified, altered or otherwise manipulated, from an emulating device to an emulated device, e.g., upon termination of an emulation of an application or termination of an emulation of a device.

Such parameters may enable an emulating device to perform operations associated with the application in the same way these operations would have been performed by the application itself. For example, polling a server, pining a remote device or providing periodic status updates on behalf of an application may be done by a special code, executed on an emulating device, and provided with parameters as described herein.

As shown by block 720, the flow may include suspending execution of the application on an emulated device and executing the application (or part of its logic) on emulating device. For example, embodiments of the invention may comprise causing a first computing device to perform or execute at least one operation related to an application normally executed on a second computing device, where the execution or performance is according to at least one functionality parameter provided as described herein. Embodiments of the invention may further comprise causing the second computing device to cease executing the application. As described herein, while an emulated device is put in sleep or similar mode, an emulating device may function on its behalf. Accordingly, an emulated device may be suspended from operation and an emulating device may operate in its place. In some embodiments, the emulating device may execute part of an application or a subset of functionalities related to an application. For example, in some cases, only one operation that is normally performed or executed by the application when it executes on the emulated device may be performed by the emulating device. At an application level or layer, an execution of a specific application may be suspended on an emulated device and commenced on an emulating device, thus, effectively, an execution of the application is transferred from the emulated device to the emulating device.

As shown by block 725, the flow may include detecting conditions requiring execution of the application on the emulated device. Embodiments of the invention may comprise detecting an awake condition by detecting a condition indicating a need for an emulated computing device to execute an application. For example, such condition may be a need for the full application to execute on the emulated device in order to handle an incoming message or an event. For example, in some embodiments, only part of an application may be actually executed on an emulating device. This may be the case, for example, when resources available to an application executing on the main (emulated) device may be unavailable to the same application when executed on an emulating device. For example, data stored on a disk connected to the emulated device may be unavailable to the same application when executed on an emulating device. For example, in an exemplary embodiment, only the part that performs periodic polls of a mail server may be executed on the emulating device as part of emulating a mail client application. Accordingly, arrival of new mail at the mail server may be a condition that calls for transferring execution of the mail client application to the emulated device so that the new mail may be retrieved from the mail server and the user may be notified. Any other conditions, rules, configuration parameters or logic may govern or effect a decision to terminate an emulation or cease executing an application on an emulating device and commence execution on the emulated device.

As shown by block 730, the flow may include providing an emulated device with updated application operational parameters. For example, at least one functionality parameter may be communicated over a network from the emulating device to the emulated device. As described herein, while executing an application, an emulating device may maintain or update any relevant parameters. Accordingly, upon determining to terminate execution of the application on the emulating device and commence execution on the emulated device, such up to date parameters may be provided to the emulated device. Accordingly, a transfer of an execution of an application from an emulating device to an emulated device may be seamless since any operational parameters or aspects may be maintained during such transfer.

As shown by block 735, the flow may include suspending execution of the application (or part of the application) on the emulating device and executing the application on the emulated device. For example and as described herein, a coordinated or synchronized procedure may comprise causing the emulated computing device to execute the application and causing the emulating computing device to cease performing the application or cease performing an operation related to the application. As described herein with respect to emulating a device, once the emulated device is fully or sufficiently operational, execution of related tasks on the emulating device may be suspended or ceased. For example, execution of any application or part of an application on an emulating device may be suspended or terminated upon respective commencement of execution of the application on the previously emulated device.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method comprising:
detecting an emulation condition, said emulation condition indicating suitability of a first computing device to execute at least one operation related to an application wherein said application is executed on a second computing device;
communicating at least one first functionality parameter associated with said application from said second computing device to said first computing device;
causing said first computing device to perform said at least one operation according to said at least one first functionality parameter;
causing said second computing device to cease executing said application;
detecting an awake condition, said awake condition indicating a need for said second computing device to execute said application;
communicating at least one second functionality parameter to said second computing device;
causing said second computing device to execute said application; and
causing said first computing device to cease performing said at least one operation.

2. The method of claim 1, wherein said at least one operation is normally performed by said second computing device when operating in a normal operational mode and wherein said second computing device maintains a reduced operational mode when said first computing device executes said at least one operation.

3. The method of claim 1, wherein said first computing device emulates a plurality of computing devices.

4. The method of claim 1, wherein said first computing device performs a plurality of operations according to a respective plurality of functionality parameters wherein said plurality of operations is further related to a respective plurality of applications and wherein said plurality of applications is normally executed on a respective plurality of computing devices.

5. The method of claim 1, wherein said first computing device, when operating according to said at least one parameter maintains a network presence of said application.

6. The method of claim 1, wherein said first computing device consumes substantially less resources than said second computing device.

7. The method of claim 1, wherein said functionality parameter is communicated over a network.

8. The method of claim 1, wherein said functionality parameter pertains to at least one of: credential information, a user name, a password, a state of an application, a configuration of an application, an address of a computing device, a port number associated with an application, an addressing parameter and a name parameter.

9. The method of claim 1, wherein detecting said awake condition comprises detecting a reset of said second computing device.

10. An apparatus configured to:
detect an emulation condition, said emulation condition indicating suitability of said apparatus to execute at least one operation related to an application wherein said application is executed on a computing device;
receive at least one first functionality parameter associated with said application from said computing device;
perform said at least one operation according to said at least one first functionality parameter;
cause said computing device to cease executing said application;
detect an awake condition, said awake condition indicating a need for said computing device to execute said application;
communicate at least one second functionality parameter to said computing device;
cause said computing device to execute said application; and
cease performing said at least one operation.

11. The apparatus of claim 10, wherein said at least one operation is normally performed by said computing device when operating in a normal operational mode and wherein said computing device maintains a reduced operational mode when said apparatus executes said at least one operation.

12. The apparatus of claim 10, wherein said apparatus emulates a plurality of computing devices.

13. The apparatus of claim 10, wherein said apparatus performs a plurality of operations according to a respective plurality of functionality parameters wherein said plurality of operations is further related to a respective plurality of applications and wherein said plurality of applications is normally executed on a respective plurality of computing devices.

14. The apparatus of claim 10, wherein said apparatus, when operating according to said at least one parameter maintains a network presence of said application.

15. The apparatus of claim 10, wherein said apparatus consumes substantially less resources than said computing device.

16. The apparatus of claim 10, wherein said functionality parameter is communicated over a network.

17. The apparatus of claim 10, wherein said functionality parameter pertains to at least one of: credential information, a user name, a password, a state of an application, a configuration of an application, an address of a computing device, a port number associated with an application, an addressing parameter and a name parameter.

18. The apparatus of claim 10, wherein detecting said awake condition comprises detecting a reset of said computing device.

19. A system comprising:
a first and second computing devices;
wherein said first computing device is configured to:
detect an emulation condition, said emulation condition indicating suitability of said first computing device to execute at least one operation related to an application executed on said second computing device;
receive at least one first functionality parameter associated with said application from said second computing device;
perform said at least one operation according to said at least one first functionality parameter;
cause said second computing device to cease executing said application;
detect an awake condition, said awake condition indicating a need for said second computing device to execute said application;
communicate at least one second functionality parameter to said second computing device;
causing said second computing device to execute said application; and
cease performing said at least one operation.

20. The system of claim 19, wherein said second computing device is configured to:
detect an emulation condition, said emulation condition indicating suitability of said first computing device to execute at least one operation related to an application executed on said second computing device;
communicate at least one first functionality parameter associated with said application to said first computing device;
cause said first computing device to perform said at least one operation according to said at least one first functionality parameter;
cease executing said application;
detect an awake condition, said awake condition indicating a need for said second computing device to execute said application;
receive at least one second functionality parameter from said first computing device;
commence execution of said application; and
cause said first computing device to cease performing said at least one operation.
